(19) United States
(12) Patent Application Publication
(10) Pub. No.: US 2007/0200906 A1
(43) Pub. Date: Aug. 30, 2007

(54) Ink Jet Printer

(75) Inventor: Hidehiko Komatsu, Suwa-shi, Nagano-ken (JP)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/622,734

(22) Filed: Jan. 12, 2007

(30) Foreign Application Priority Data
Jan. 13, 2006 (JP) 2006-005761

(51) Int. Cl. B41J 2/185

(52) U.S. Cl. 347/90

(57) ABSTRACT

To provide a capturing member that not only can reliably capture and guide ink droplets ejected into a region other than a recording medium into a waste ink tank in borderless printing by ink jet recording, but also does not deteriorate due to nonaqueous ink and can effectively prevent or suppress formation of ink mist, and also provide an ink jet printer including the capturing member. A capturing member for directly capturing ink droplets of a nonaqueous ink composition ejected from an ink jet recording head into a region other than a recording medium comprises a porous plastic produced by molding and sintering plastic particles. An ink jet printer comprises the capturing member.

### BACKGROUND OF INVENTION

1. Technical Field

The present invention relates to capturing members and ink jet printers including such capturing members. In borderless printing by ink jet recording using nonaqueous ink, for example, a capturing member according to the present invention can reliably capture ink droplets of the nonaqueous ink ejected into a region other than a recording medium and guide the ink droplets into a waste ink tank. In addition, the capturing member can effectively prevent or suppress formation of ink mist without deterioration due to the nonaqueous ink.

2. Background Art

As in film photography, borderless printing is performed in ink jet recording. In borderless printing, an image must be printed over the entire surface of a recording medium without leaving non-image regions (margins) on the periphery of the recording medium. An appropriate image can be formed so as to cover the periphery of the recording medium by continuous ejection of ink droplets from a printer head over a region extending from the surface to the outside of the periphery of the recording medium. A known mechanism of borderless printing will be described with reference to the attached drawings.

First, the mechanism of borderless printing is schematically shown in FIGS. 1 and 2. FIGS. 1(A), 1(B), and 1(e) are schematic enlarged perspective views of the main part of an ink jet recording apparatus during a borderless printing process, showing printing at the front edge of a recording medium, printing at a side edge of the recording medium, and printing at the rear edge of the recording medium, respectively. FIG. 2 is a schematic side view of the main part of the ink jet recording apparatus shown In FIG. 1(A).

In FIGS. 1 and 2, an ink jet recording apparatus 10 includes a recording head 13 mounted on a carriage 14 that reciprocates along a guide shaft 12 extending in a main scanning direction (i.e., in the lateral direction of a recording sheet 11, as indicated by arrow B of FIG. 1) and a platen (not shown) disposed below the recording head 13 so as to face the recording head 13. The recording sheet 11 is transported between the recording head 13 and the platen in a sub-scanning direction (in a direction indicated by arrow A of FIGS. 1 and 2) by sheet-feeding means (not shown).

In FIGS. 1(A) and 2, printing is started from a front edge 11a of the recording sheet 11 after the recording sheet 11 is transported until the front edge 11a is positioned under the recording head 13. When the printing is started, the recording head 13 ejects ink droplets 19 onto the recording sheet 11 while reciprocating along the guide shaft 12 in the main scanning direction (in the direction indicated by arrow B). The recording head 13 also ejects the ink droplets 19 to the outside of the front edge 11a of the recording sheet 11 to perform printing without leaving a margin at the front edge 11a of the recording sheet 11. The ink droplets 19 ejected to the outside of the recording sheet 11 land directly on a capturing member 30 disposed on the platen and permeate through the capturing member 30 to form an ink-captured region 31.

After the completion of the printing at the front edge 11a of the recording sheet 11, the recording sheet 11 is transported in the sub-scanning direction (in the direction indicated by arrow A) for printing in the center of the recording sheet 11. In FIG. 1(B), the recording head 13 also ejects the ink droplets 19 to the outside of side edges 11b of the recording sheet 11 to perform printing without leaving margins at the side edges 11b of the recording sheet 11. The ink droplets 19 ejected to the outside of the recording sheet 11 land directly on the capturing member 30 disposed on the platen and are captured by the capturing member 30. After the completion of the printing in the center of the recording sheet 11, the recording sheet 11 is transported in the sub-scanning direction (in the direction indicated by arrow A) for printing at a rear edge 11c of the recording sheet 11. In FIG. 1(e), the recording head 13 also ejects the ink droplets 19 to the outside of the rear edge 11c of the recording sheet 11 to perform printing without leaving a margin at the rear edge 11c of the recording sheet 11. The ink droplets 19 and directly on the capturing member 30 disposed on the platen and are captured by the capturing member 30.

Because the ink droplets 19 are ejected to the outside of the recording sheet 11 in borderless printing, as shown In FIGS. 1 and 2, a capturing member must be provided on the platen to prevent contamination of, for example, the back surface of the recording sheet 11 with the ink droplets 19 ejected to the outside of the recording sheet 11. A typical ink jet recording apparatus having a platen with a capturing member is shown in FIGS. 3 to 5. FIG. 3 is a perspective view of a typical ink jet recording apparatus 10A, particularly showing a printing unit with a case cover 1 opened. The printing unit includes a carriage 4 on which ink cartridges 2 and 3 and a recording head 4A are mounted, a platen 5 disposed opposite a path on which the carriage 4 moves, first sheet-pressing rollers 6 disposed upstream of the platen 5 In a direction in which a recording sheet is ejected, and second sheet-pressing rollers 7 disposed downstream of the platen 5. FIG. 4 is a partial plan view of the printing unit of the ink jet recording apparatus 10 shown in FIG. 3. FIG. 5 is a partial sectional view of the printing unit of the ink jet recording apparatus 10 shown in FIG. 3.

In FIGS. 4 and 5, particularly, a capturing member 20 is disposed below the platen 5, which has platen openings 5a, 5b, and 5c. The platen opening 5a is a window for allowing the capturing member 20 to directly capture ink droplets and thus prevent deposition of the ink droplets to the surface of the platen 5 and formation of ink mist during printing at a front edge of a recording sheet P. The platen openings 5b are windows used in printing at side edges of the recording sheet P. The platen opening 5c is a window used in printing at a rear edge of the recording sheet P. Thus, all ink droplets ejected from the recording head 4A to the outside of the recording sheet P pass through the platen openings 5a, 5b, and 5c and are directly captured by the capturing member 20. The recording sheet P is transported with the back surface thereof in contact with the surface of the platen 5. The capturing member 20 must therefore be positioned at such a height that the back surface of the recording sheet P does not come into contact with the top surface of the capturing member 20.

In FIG. 5, the capturing member 20 is supported by a support 8 having support openings 8a. The capturing member 20 temporarily captures the ink, which then flows gradually into a waste ink tank 9 disposed below the support through the support openings 8a. The ink is typically absorbed and retained by an absorber/retainer provided on the waste ink tank 9. In the present specification, the terms “above” and “below” are defined with respect to the gravitational direction in the context of a printer under printing operation.

Pigment ink has recently been used mainly for the purpose of improving print durability. For pigment ink, particularly, a solvent component permeates through a capturing member with pigment particles left and deposited on the surface of the capturing member because the capturing member is generally formed of a porous material (for example, polyurethane foam). When the pigment deposits grow gradually on the surface of the porous capturing member and protrude upward from platen openings, the pigment particles adhere to the back surface of a recording sheet, and can also be transferred to the surface of the platen, thus contaminating the back surface of another recording sheet.

Some techniques for preventing deposition of pigment particles have been proposed, which are intended mainly for aqueous ink. Examples of such known techniques include impregnation of a capturing member with organic solvent (Patent Document 1), impregnation of a capturing member with organic solvents selected for different colors of pigment inks (Patent Document 2), use of a multilayer capturing member having two or more layers including a receiving layer and a diffusing layer (Patent Document 3), and facilitation of permeation into a capturing member via through-holes (Patent Document 4).

Borderless printing can be performed not only in ink jet recording using aqueous ink, but also in ink jet recording using nonaqueous ink (oil-based ink). However, borderless printing using nonaqueous ink (oil-based ink) has specific problems different from those of borderless printing using aqueous ink. For example, a capturing member must be formed of a material selected from a different viewpoint because components contained in nonaqueous ink can chemically damage and degrade polyurethane foam, which is widely used as the material of a capturing member in borderless printing using aqueous ink. In addition, borderless printing using nonaqueous ink tends to cause ink mist under the effect of static electricity; this tendency appears more significantly with decreasing nozzle diameter.

Unfortunately, no attention has been paid to the above problems specific to borderless printing by ink jet recording using nonaqueous ink, and accordingly few solutions to these problems have been proposed.

[Patent Document 1] JP-A-2003-191545

[Patent Document 2] JP-A-2004-174978

[Patent Document 3] JP-A-2003-39754

[Patent Document 4] JP-A-2004-1485

### SUMMARY OF THE INVENTION

Accordingly, an object of the present invention is to provide a capturing member that not only ensures its intended function (that is, the function of reliably capturing ink droplets ejected into a region other than a recording medium and guiding the ink droplets into a waste ink tank In borderless printing by ink jet recording), but also can solve the problems specific to borderless printing by ink jet recording using nonaqueous ink and, particularly, can provide stability against chemical erosion due to components contained in nonaqueous ink (degradation resistance) and suppress formation of mist.

The above problems can be solved by a capturing member according to the present invention for directly capturing ink droplets of a nonaqueous ink composition ejected from an ink jet recording head into a region other than a recording medium. This capturing member comprises a porous plastic produced by molding and sintering plastic particles.

In a preferred embodiment of the present invention, the plastic particles are polyolefin resin particles, vinyl resin particles, polyester resin particles, polyamide resin particles, polystyrene resin particles, acrylic resin particles, polysulfone resin particles, poly(ether sulfone) resin particles, poly(ethylene sulfide) resin particles, fluorocarbon resin particles, cross-linked polyolefin resin particles, or a mixture thereof. In another preferred embodiment of the present invention, the nonaqueous ink composition is a nonaqueous pigment ink composition.

The present invention also relates to an ink jet printer comprising the capturing member.

The capturing member according to the present invention not only ensures its intended function (that is, the function of reliably directly capturing ink droplets ejected into a region other than a recording medium and guiding the ink droplets into a waste ink tank in borderless printing by ink jet recording), but also can solve the above problems specific to borderless printing by ink jet recording using nonaqueous ink. In particular, the capturing member does not deteriorate because of sufficient stability against chemical erosion due to components contained in nonaqueous ink (for example, chemical resistance and resistance to organic solvent) and can effectively suppress formation of mist.

### BRIEF DESCRIPTION OF THE DRAWINGS

FIG. 1 shows schematic enlarged perspective views of the main part of an ink jet recording apparatus during a borderless printing process.

FIG. 2 is a schematic side view of the main part of the ink jet recording apparatus shown In FIG. 1(A).

FIG. 3 is a perspective view of a typical ink jet recording apparatus.

FIG. 4 is a partial plan view of a printing unit of the ink jet recording apparatus shown in FIG. 3.

FIG. 5 is a partial sectional view of the printing unit of the ink jet recording apparatus shown In FIG. 3.

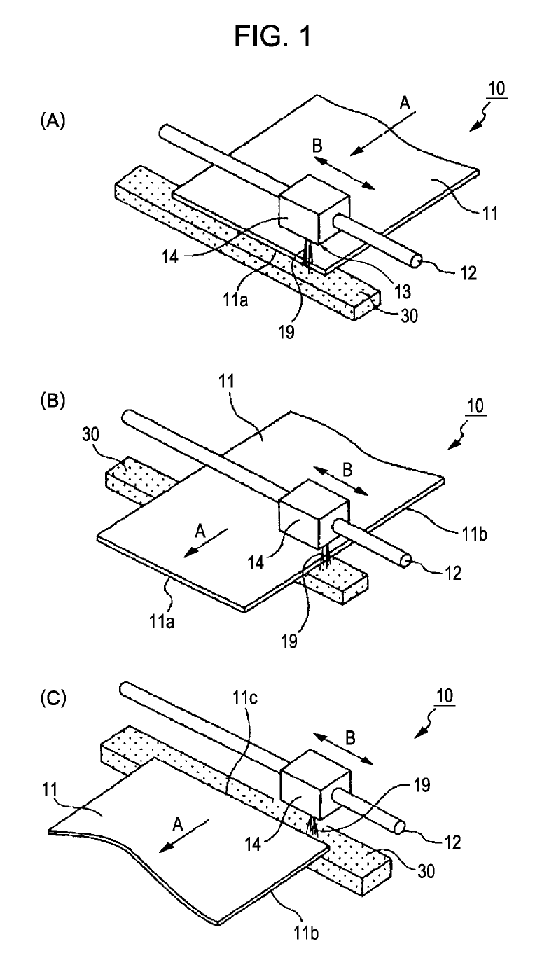

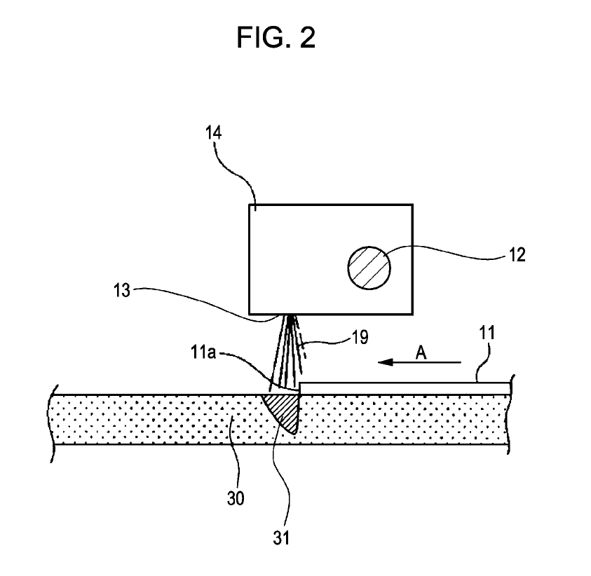

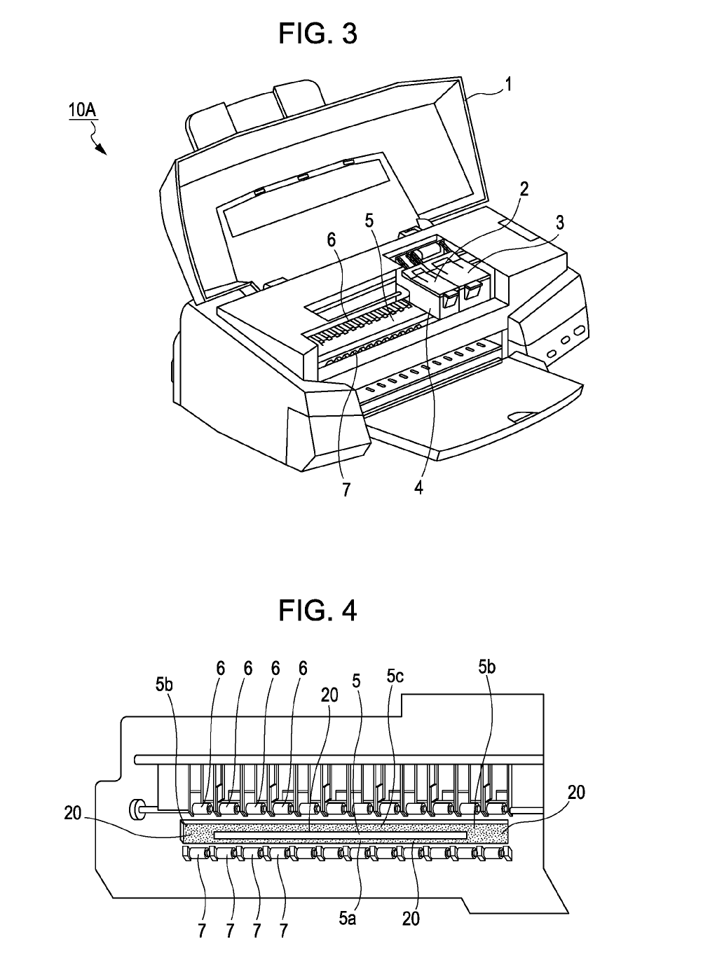

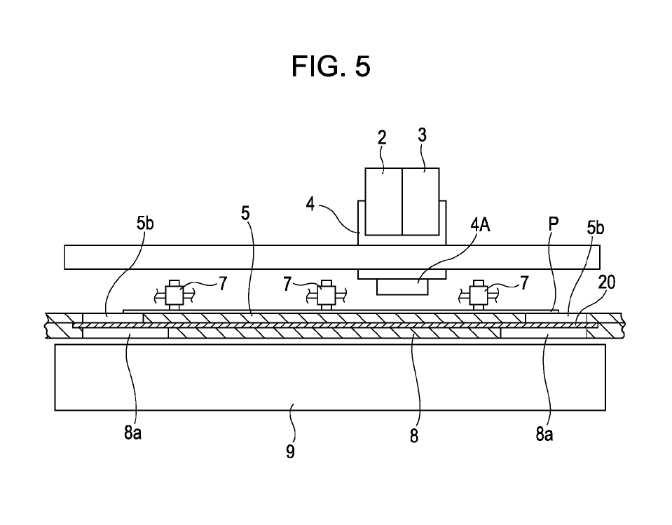

### DETAILED DESCRIPTION OF INVENTION

A capturing member according to the present invention is formed of a porous plastic produced by molding and sintering plastic particles. The plastic particles may be thermoplastic particles such as polyolefin resin particles (for example, polyethylene, such as ultrahigh-molecular weight polyethylene or high-density polyethylene, or polypropylene), vinyl resin particles (for example, poly(vinyl chloride) resin), polyester resin particles (for example, polyarylate), polyamide resin particles, polystyrene resin particles, acrylic resin particles, polysulfone resin particles, poly(ether sulfone) resin particles, poly(ethylene sulfide) resin particles, fluorocarbon resin particles, cross-linked polyolefin resin particles, or a mixture thereof.

Examples of fluorocarbon resins include polytetrafluoroethylene, poly(fluoroacryl acrylate), poly(vinylidene fluoride), poly(vinyl fluoride), and hexafluoropropylene.

Cross-linked polyolefin resin materials are prepared by crosslinking a polyolefin resin such as polyethylene, for example, low-density polyethylene, medium-density polyethylene, or high-density polyethylene, or polypropylene through irradiation with ionizing radiation such as gamma rays or X-rays, or by chemically crosslinking a polyolefin resin using an inorganic compound such as aluminum chloride or nitrogen fluoride or an organic peroxide such as t-butylcumyl peroxide, dicumyl peroxide, 2,5-dimethyl-2,5-di(t-butylperoxy)hexane, or acetylene peroxide as an crosslinking agent.

The plastic particles preferably have an average particle size of, for example, 1,000 ˜m or less, although the particle size is not particularly limited. In addition, the plastic particles are preferably formed of a material having a melt flow rate (MFR) of, for example, 0.01 or less to produce a sintered porous plastic having a uniform pore size, although the MFR is not particularly limited.

The porous plastic used in the present invention can be produced by molding and sintering the thermoplastic particles through static molding or dynamic molding.

An example of static molding is an in-mold sintering process in which thermoplastic particles are charged into a cavity defined inside a mold and are heated together with the mold.

Examples of dynamic molding include (1) ram extrusion using a ram extruder, which has a temperature-controllable cylinder, a mold at the leading end of the cylinder, and a reciprocating piston (plunger) in the cylinder; (2) injection molding using an injection molding machine, which has a temperature-controllable cylinder, a mold at the leading end of the cylinder, and a screw in the cylinder; (3) extrusion molding using an extruder, which has a temperature-controllable cylinder, a mold at the leading end of the cylinder, and a screw in the cylinder; (4) compression molding using a compression molding machine, which has a mold composed of a female half having a cavity to be filled with a raw material before heating of the mold and a male half for insertion into the female half, and (5) continuous pressing using a continuous pressing machine, which has a temperature-controllable cylinder and a mold for extruding a raw material including a pair of upper and lower moving belts, or a lower moving belt, at the leading end of the cylinder.

An appropriate process may be selected from such static and dynamic molding processes according to, for example, the final shape and properties of the porous plastic used in the present invention.

The sintered porous plastic compact (board) thus produced, which is similar in appearance to general plastic compacts (boards), actually has a countless number of pores interconnected multidirectionally. Such a sintered porous plastic compact is commercially available in various core sizes (for example, Porex Porous Plastic (Porex Technologies) and Fildus (Mitsubishi Plastics, Inc.))

Antistatic properties can be imparted to the capturing member according to the present invention by, for example, adding a conductive agent such as carbon black, carbon fiber, metal powder, or metal-coated potassium titanate particles to the thermoplastic particles in an amount of, for example, 1% to 5% by weight (preferably, 1% to 2% by weight) before the mixture is molded and sintered. Such an antistatic treatment can significantly suppress formation of mist due to static electricity.

A nonaqueous ink composition to be captured by the capturing member according to the present invention is not particularly limited. The capturing member according to the present invention can successfully capture any known nonaqueous ink composition (oil-based ink composition) used for ink jet recording. Nonaqueous ink compositions for use in ink jet recording mainly contain a pigment, an organic solvent, and a dispersant.

Various inorganic and organic pigments that can be used for general nonaqueous ink compositions for ink jet recording can be used. Examples of particularly useful pigments include:

C.I. pigment yellow 74, 93, 95, 109, 110, 120, 128, 138, 139, 151, 154, 155, 173, 180, 185, and 193;

C.I. pigment orange 34, 36, 43, 61, 63, and 71;

C.I. pigment red 122 and 202 and a solid solution thereof;

C.I. pigment blue 15:1, 15:2, 15:3, 15:4, and 16;

C.I. pigment violet 19, 23, and 33;

C.I. pigment green 7 and 36; and

C.I. pigment black 7.

The amount of pigment used in the nonaqueous ink composition to be captured by the capturing member according to the present invention is preferably 0.5% to 30% by weight, more preferably about 1% to 10% by weight, of the total weight of the nonaqueous ink composition. An ink composition containing an insufficient amount of pigment exhibits low ink color density. On the other hand, an ink composition containing an excessive amount of pigment is difficult to use for printing in terms of ink viscosity and flowability.

Various organic solvents that can be used for general nonaqueous ink compositions for ink jet recording can be used for the nonaqueous ink composition to be captured by the capturing member according to the present invention. For example, saturated hydrocarbon solvents can be used. Saturated hydrocarbon solvents are exemplified by commercially available saturated hydrocarbon solvents often used for known nonaqueous ink compositions for ink jet recording (particularly, oil-based ink compositions), including isoparaffinic mixtures such as ISOPAR E, ISOPAR G, ISOPAR H, ISOPAR L, ISOPAR M (manufactured by Exxonmobil Chemical Company), Shell sol (manufactured by Shell Chemicals Limited), Soltrol (manufactured by Phillips Petroleum Company), Vegasol (manufactured by Mobil Oil Corporation), and IP Solvent 2835 (manufactured by Idemitsu Kosan Co., Ltd.) and cycloparaffinic mixtures such as Exxsol 0130 (manufactured by Exxonmobil Chemical Company). In addition, commercially available liquid paraffins (including those called light liquid paraffins in the Japanese Pharmacopoeia), which are mixtures mainly containing normal paraffins, isoparaffins, and monocycloparaffins, may be used, including MORESCO—WHITE P-40 and MORESCO—WHITE P-55 (manufactured by Matsumura Oil Research Corp.) and Liquid paraffin Nos. 40-S and 55-S (manufactured by Chuokasei Co., Ltd.).

Other examples include normal paraffinic hydrocarbons such as octane, nonane, decane, and dodecane; isoparaffinic hydrocarbons such as isooctane, isodecane, and isododecane; and cycloparaffinic hydrocarbons such as cyclohexane, cyclooctane, cyclodecane, and decalin.

Among the above saturated hydrocarbon solvents, a mixture of a cycloparaffinic solvent with high surface tension and an isoparaffinic solvent with a low melting point and a high boiling point is preferred to achieve excellent ink ejection stability over a wide temperature range. If such solvents are used in combination, the amount of cycloparaffinic solvent used is preferably 20% to 70% by weight of the total amount of the mixture, and the amount of isoparaffinic solvent used is preferably 30% to 80% by weight of the total amount of the mixture. In particular, liquid paraffins are most preferable because they contain two such components in desired proportions.

The saturated hydrocarbon solvent used preferably has a viscosity of 20 mPas or less at 25° C. in terms of ink ejection stability. A saturated hydrocarbon solvent having such a viscosity may be prepared by mixing a low-viscosity saturated hydrocarbon solvent and a high-viscosity saturated hydrocarbon solvent. In addition, the saturated hydrocarbon solvent preferably has a boiling point of 180° C. to 360° C. at 760 mmHg in terms of both an increase in printing speed, which depends on evaporation and drying, and nozzle clogging. If a mixture of saturated hydrocarbon solvents is used, most of the components preferably have a boiling point within the range described above.

A vegetable oil can be used as another organic solvent In combination to improve the solubility of the pigment dispersant. Examples of the vegetable oil include semidrying oils such as soybean oil, cottonseed oil, sunflower oil, rapeseed oil, mustard oil, sesame oil, and corn oil; non-drying oils such as olive oil, peanut oil, and camellia oil; and drying oils such as linseed oil and safflower oil. These vegetable oils can be used alone or in combination.

If a vegetable oil is used as an organic solvent in combination with the saturated hydrocarbon solvent, the weight ratio between the saturated hydrocarbon solvent and the vegetable oil is preferably 100: (10-100), more preferably 100: (12-60). In addition, the sum of the contents of the saturated hydrocarbon solvent and the vegetable oil is preferably 70% or more by weight, more preferably 80% or more by weight, of the total amount of organic solvent.

To control drying properties, a melting point, or viscosity, for example, a lower alcohol or alkyl ether solvent miscible with the saturated hydrocarbon solvent may be added to the organic solvent of the nonaqueous ink composition if necessary within such a range as not to decrease other properties such as surface tension. Examples of such a solvent include methanol, ethanol, propanol, and (poly)alkylene glycols such as (poly) ethylene glycol and (poly)propylene glycol.

The dispersant used may contain various dispersants that can be used for general nonaqueous ink compositions for ink jet recording, including a variety of pigment dispersants and high-molecular-weight pigment dispersant resins soluble in the organic solvent. Preferred pigment dispersants are exemplified by reaction products of an amine and a self-condensation product of 12-hydroxystearic acid, including a reaction product of polyallylamine and a self-condensation product of 12-hydroxystearic acid; a reaction product of polyethylene polyamine and a self-condensation product of 12hydroxystearic acid, for example, Solsperse 13940, manufactured by Zeneca Inc.; and a reaction product of a dialkylaminoalkylamine and a self-condensation product of 12-hydroxystearic acid, for example, Solsperse 17000 and 18000, manufactured by Zeneca Inc.

Other examples of the pigment dispersants include long chain alkylamine acetates such as octadodecylamine acetate; quaternary ammonium salts such alkyl (hardened beef tallow)trimethylammonium chloride; polyoxyethylene derivatives such as polyoxyethylene monostearate; sorbitan esters of long-chain aliphatic acids, such as sorbitan monooleate, sorbitan monolaurate, and sorbitan monostearate; pigment derivatives such as Solsperse 5000 (manufactured by Zeneca Inc.); and polyamines such as EFKA 47 (manufactured by EFKA Chemicals).

Examples of the pigment dispersant resins include petroleum resin, rosin-modified maleic resin, rosin-modified phenolic resin, alkylphenolic resin, alkyd resin, aminoalkyd resin, acrylic resin, polyamide resin, and coumarone-indene resin.

The amount of dispersant used is, for example, about 0.1 to 10 times by weight that of pigment used. In addition, various binder resins used for general nonaqueous ink compositions for ink jet recording may be used to improve, for example, adhesion to a printing material. Furthermore, various other additives such as a surfactant, a viscosity modifier, an antifoaming agent, and a deposition aid may be added.

The nonaqueous ink composition preferably has a viscosity of, for example, 1.0 to 30.0 mPas, more preferably 3.0 to 10.0 mPas, at an ambient temperature during use. If the viscosity falls within such a range, the nonaqueous ink composition excels in ejection stability and permeation through the capturing member in high-speed printing. In addition, the nonaqueous ink composition preferably has a surface tension of, for example, 26 to 30 dyne/em at 25° C.

Ink droplets deposited on the surface of the sintered porous plastic constituting the capturing member according to the present invention not only can quickly permeate through the capturing member (in the gravitational direction), but also can diffuse over the surface of the capturing member (in the horizontal direction). The capturing member according to the present invention is thus suitable for use In a printer including a printer head for color printing having a structure in which no ink droplets land on ink droplets deposited on a surface of a capturing member.

When ink droplets land on a surface of a capturing member, not all components thereof can permeate through the capturing member, and some components can be left on the surface. The residual components are dried and solidified through contact with air to form pigment deposits protruding from the surface. If other ink droplets land on the residual ink components, the ink droplets can cause the residual components to permeate through the capturing member. The residual ink components, however, have no chance of permeating through the capturing member if the color printer head used has a structure in which no ink droplets land on ink droplets deposited on the surface of the capturing member and, additionally, if the capturing member lacks the ability to diffuse the ink components horizontally. In that case, the residual components tend to dry and solidify continuously. In contrast, as described above, the sintered porous plastic constituting the capturing member according to the present invention has the ability to diffuse the ink components horizontally. The capturing member can therefore effectively suppress the drying and solidification of the residual components on the surface thereof when used in a printer including a printer head for color printing having a structure In which no ink droplets land on ink droplets deposited on a surface of a capturing member.

### EXAMPLES

The present invention will be specifically described with reference to the examples below, although they do not limit the scope of the invention. In the examples, the terms “parts” and “%” are based on weight unless otherwise specified.

### Example 1

(1) Preparation of Capturing Member

Ultrahigh-molecular-weight polyethylene particles having an average particle size of 160 ˜m and a melt flow rate (MFR) of not more than 0.01 was charged into a mold cavity having a rectangular cross section so as to form a layer having a thickness corresponding to 70% of the total thickness of the final filter. The polyethylene particles were heated at 160° C. to 220° C. for 30 minutes to prepare a porous capturing member having a large particle size and a large pore size.

(2) Preparation of Black Ink Composition

Solsperse 17000 (3 parts) was dissolved as a dispersant In Liquid Paraffin No. 40-8 (12 parts). This solution was mixed and stirred with 5 parts of Carbon Black MA-7 (manufactured by Mitsubishi Chemical Corporation) as a pigment. The pigment was dispersed using an Eiger mill to prepare a black dispersion. Next, Liquid Paraffin No. 40-8 (40 parts) and I80PAR M (45 parts) were added to the above black dispersion (15 parts), which was stirred to prepare a black ink composition. ISOPAR M is a mixture of isoparaffins (manufactured by Exxonmobil Chemical Company). The black ink composition had a surface tension of 28 mN/m and a viscosity of 8 mPas.

(3) Evaluation of Physical Properties

The capturing member prepared in Item (1) and the black ink composition prepared in Item (2) were set to an ink jet printer (PX-V600, manufactured by Seiko Epson Corporation) Borderless printing was continuously performed on 500 postcards at 40° C. and a relative humidity of 20%. As a result, the ink composition successfully permeated through the capturing member without leaving pigment deposits on the surface thereof. Observation of the capturing member after the printing and removal from the printer confirmed that the capturing member had excellent durability without deformation or deterioration. Observation of the postcards after the printing found no contamination due to mist on any of the postcards.

The capturing member according to the present invention is useful as a capturing member for capturing nonaqueous ink droplets ejected into a region other than a recording medium In borderless printing by ink jet recording using nonaqueous ink, particularly, useful as a capturing member for nonaqueous pigment ink printers.

1. A capturing member for directly capturing ink droplets of a nonaqueous ink composition ejected from an ink jet recording head into a region other than a recording medium, the capturing member comprising:
a porous plastic produced by molding and sintering plastic particles.

2. The capturing member according to claim 1, wherein the plastic particles comprise at least one of or a mixture of:
polyolefin resin particles;
vinyl resin particles;
polyester resin particles;
polyamide resin particles;
polystyrene resin particles;
acrylic resin particles;
polysulfone resin particles;
poly(ether sulfone) resin particles;
poly(ethylene sulfide) resin particles;
fluorocarbon resin particles; and
cross-linked polyolefin resin particles.

3. The capturing member according to claim 1, wherein the nonaqueous ink composition is a nonaqueous pigment ink composition.

4. An ink jet printer comprising
an ink jet recording head; and
a capturing member for directly capturing ink droplets of a nonaqueous ink
composition ejected from the ink jet recording head into a region other than a recording medium the capturing member comprising:
a porous plastic produced by molding and sintering plastic particles.

5. The ink jet printer according to claim 4, wherein the plastic particles comprise at least one of or a mixture of:
polyolefin resin particles;
vinyl resin particles;
polyester resin particles;
polyamide resin particles;
polystyrene resin particles;
acrylic resin particles;
polysulfone resin particles;
poly(ether sulfone) resin particles;
poly(ethylene sulfide) resin particles;
fluorocarbon resin particles; and
cross-linked polyolefin resin particles.

6. The capturing member according to claim 5, wherein the nonaqueous ink composition is a nonaqueous pigment ink composition.

7. The capturing member according to claim 4, wherein the nonaqueous ink composition is a nonaqueous pigment ink composition.

8. The capturing member according to claim 2, wherein the nonaqueous ink composition is a nonaqueous pigment ink composition.
